(19) United States
(12) Patent Application Publication
(10) Pub. No.: US 2007/0157150 A1
(43) Pub. Date: Jul. 5, 2007

(54) Base project resource management and application synthesis

(76) Inventors: Kenneth Y. Ogami, Bothell, WA (US); Doug Anderson, Edmonds, WA (US); Marat Zhaksilikov, Snohomish, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/516,141

(22) Filed: Sep. 5, 2006

Related U.S. Application Data
(60) Provisional application No. 60/741,727, filed on Dec. 1, 2005.
(60) Provisional application No. 60/741,650, filed on Dec. 1, 2005.

(51) Int. Cl. G06F 17/50

(52) U.S. Cl. 716/16

(57) ABSTRACT

In one embodiment, a method for constructing an application includes detecting a change to a design of an application, evaluating the design against hardware resources associated with application projects to identify one or more applicable application projects, receiving a user selection of an applicable application project, and constructing the application using the selected application project.

### CROSS-REFERENCE TO RELATED APPLICATIONS

This application claims the benefit of U.S. Provisional Applications Nos. 60/741,727 and 60/741,650, both filed Dec. 1, 2005, and incorporated herein by reference in their entirety.

### BACKGROUND

1. Field

Embodiments of the invention relate generally to application development and more specifically, but not exclusively, to managing resources of an application project.

2. Background Information

Embedded system design tools assist users in the creation of applications to be programmed into processing devices such as microcontrollers. One existing embedded system design tool allows a system designer to create an embedded application by combining system input and output (I/O) devices such as LEDs, switches, sensors and fans. The embedded system design tool uses I/O device drivers that represent I/O devices to a user. An I/O driver maps onto a channel that provides an adaptation layer between the I/O driver and microcontroller peripherals. For each type of microcontroller, several application projects are predefined with different selections of channel resources. An application project describes hardware components (e.g., blocks, pins, etc.) of a specific microcontroller. When constructing an embedded application, the embedded system design tool finds an application project with channel resources sufficient to accommodate 1/O devices specified by the user. This application project is then composed into a final device project that is compiled into a binary file for the download to the designated microcontroller.

One limitation of the embedded system design tool described above is that it utilizes application projects with a fixed selection of channel resources and pin interconnections. As such, embedded applications generated from these application projects are limited in the possible combinations of I/O devices and their pin interconnection. In addition, these embedded applications often include code that is not necessary to implement the specific I/O devices selected by the user, wasting ROM and RAM space in the final embedded application. Furthermore, a potentially unmanageable number of application projects may need to be created manually to cover the possible combinations of I/O devices available to the users.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an exemplary system in which embodiments of the present invention may operate.

FIG. 2 illustrates a firmware stack model in accordance with one embodiment of the invention.

FIG. 3 is a block diagram of one embodiment of a processing device maker.

FIG. 4 illustrates an exemplary design composition user interface.

FIG. 5 illustrates an exemplary device selection user interface.

FIG. 6 is a flow diagram of one embodiment of a method for constructing a custom application.

FIG. 7 is a flow diagram of one embodiment of a method for instantiating channels for a specific base project.

FIG. 8A illustrates an exemplary pin assignment user interface.

FIG. 8B illustrates data components of a placeable channel.

FIG. 9 is a flow diagram of one embodiment of a base project synthesis method.

FIG. 10 is a block diagram of one embodiment of a processing device.

FIG. 11 is a block diagram of one embodiment of a computer system.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following description and claims, the term “coupled” and its derivatives may be used. “Coupled” may mean that two or more elements are in direct contact (physically, electrically, magnetically, optically, etc.). “Coupled” may also mean two or more elements are not in direct contact with each other, but still cooperate or interact with each other.

Embodiments of the present invention utilize application composition mechanisms to dynamically construct customized applications for programming processing devices such as microcontrollers. These application composition mechanisms allow mixing and matching of hardware resources as long as the processing device can support the needed resources, thus providing maximum utilization of the hardware resources for a given project of an application.

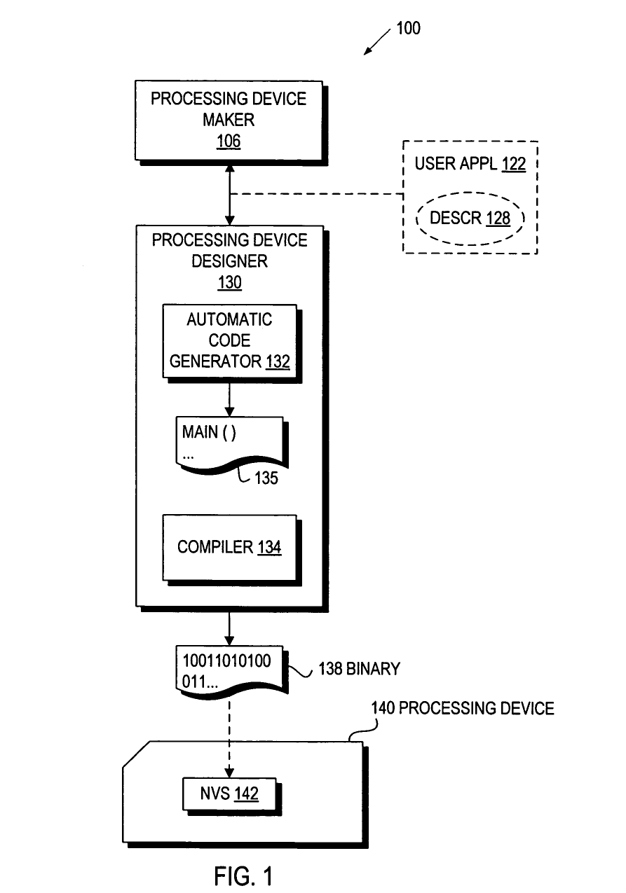

FIG. 1 illustrates an exemplary system 100 in which embodiments of the present invention may operate. The system 100 provides automated code generation of processing device firmware in accordance with one embodiment of the present invention.

The system 100 includes a processing device maker 106 that is responsible for constructing a user application 127 for implementation on a processing device 140. The user application 127 may be described in a user application description 128. In one embodiment, the user application description 128 is a text file that describes the user's application 127.

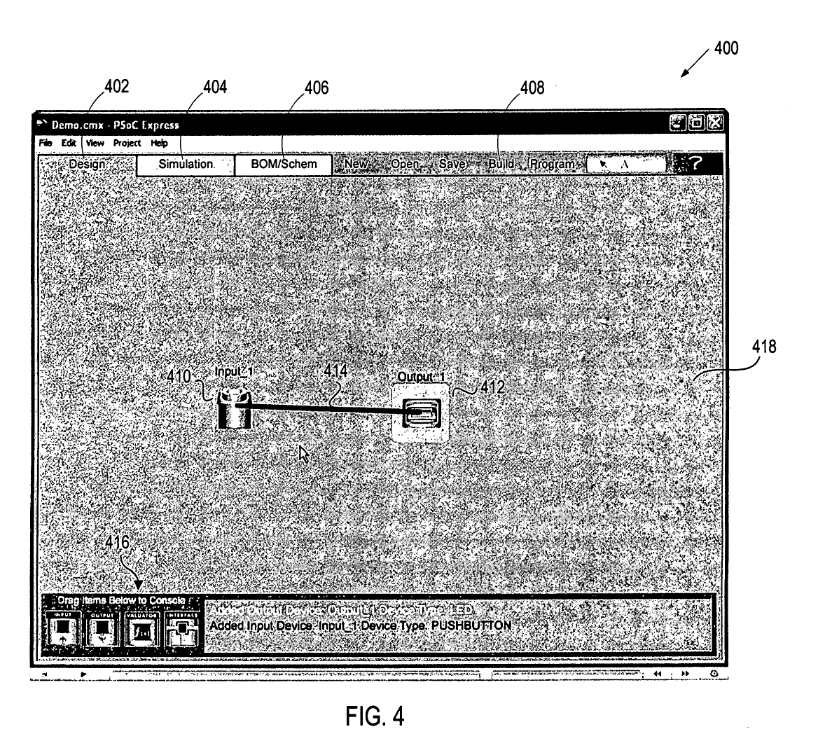

In one embodiment, the processing device maker 106 provides a design composition user interface (UI) that allows a user to select input and output (I/O) devices for the design of the application 127. An exemplary design composition user interface will be discussed in more detail below in conjunction with FIG. 4.

After the user completes the design of the application 127, the user may perform a simulation of the user application 127. The simulation capability enables hardware independence by verifying the application behavior without requiring the user to compile and debug the firmware on the targeted processing device. Simulation also includes the ability to create complex input files to exhaustively test the application behavior with arbitrarily large combinations of input values. The simulation logs the outputs based on the application behavior so that the results may be analyzed by the user.

Next, the user may request that processing device code be automatically generated. The user does not have to perform any actual coding. In one embodiment, after the user selects the targeted processing device 140, the user application description 128 is handed-off to a processing device designer 130 for the generation of processing device code. The processing device designer 130 may include an automatic code generator 132 that assembles the code for the user's application 127 based on the user application description 128. The automatic code generator 132 generates processing device code 135 (e.g., high-level language code, such as C, low-level code, such as Assembly, or a combination thereof).

A compiler 134 compiles the code 135 to generate a binary 138, also known as a binary image or a Read-Only Memory (ROM) image. The binary 138 is loaded into a Non-Volatile Storage (NVS) 142 of the processing device 140. In one embodiment, NVS 142 includes flash memory.

Embodiments of the processing device 140 may include one or more general-purpose processing devices, such as a microprocessor or central processing unit, a network processor, a microcontroller, an embedded Programmable Logic Device (PLD), or the like. Alternatively, the processing device may include one or more special-purpose processing devices, such as a Digital Signal Processor (DSP), an Application Specific Integrated Circuit (ASIC), a Field Programmable Gate Array (FPGA), or the like. The processing device may also include any combination of a general-purpose processing device and a special-purpose processing device.

It will be appreciated that the code 135 is constructed from pre-built and pre-tested code libraries, thus eliminating time wasted on debugging, such as finding syntax errors. It will also be appreciated that the user has generated the user application 127 without referencing a targeted processing device. Instead of choosing a processing device to implement a user application and then writing code for that processing device, embodiments of the present invention allow a user application to be created and then code automatically generated for a particular processing device. Moreover, a user may take a user application, make revisions to the user application, and quickly generate revised programming device code.

As discussed above, the processing device maker 106 allows the user to select 1/O devices for the user application 127. In one embodiment, the processing device maker 106 uses device drivers that represent I/O and interface devices to the user. Generally, a device driver is a building block used in the construction of the user application 127. In one embodiment, a device driver maps onto a channel that provides an adaptation layer between the device driver and processing device peripherals. A channel represents resource needs of a hardware function associated with a corresponding device driver. The processing device maker 106 evaluates a combination of channels pertaining to the user application 127 and finds applicable processing devices that are capable of accommodating the channels' resource needs. Subsequently, when the user requests to generate processing device code for the user application 127, the processing device maker 106 allows the user to select a desired processing device (targeted processing device 140) from the applicable processing devices described above.

In one embodiment, the processing device maker 106 finds applicable processing devices using predefined application projects (also referred to herein as base projects). A base project describes hardware components (e.g., blocks, pins, etc.) of a specific processing device.

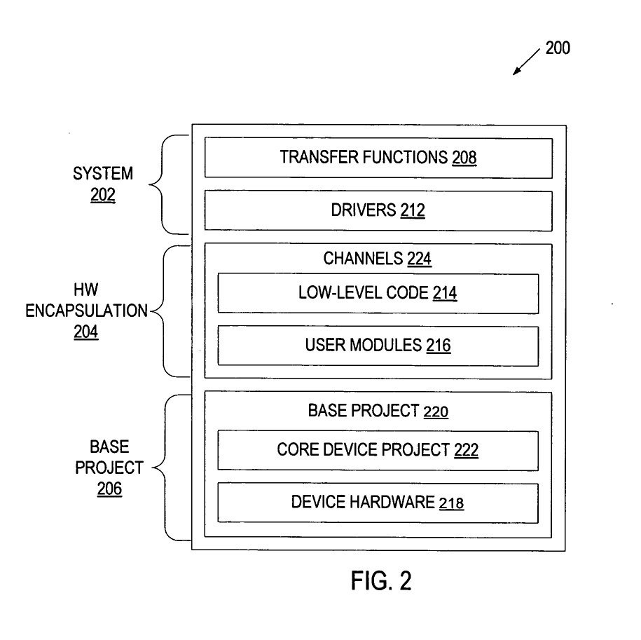

FIG. 2 illustrates a firmware stack model 200 in accordance with one embodiment of the invention. Firmware stack 200 shows a logical structure of at least a portion of the processing device code 135. A portion of the stack 200 is abstracted away from specific hardware. Such hardware independency provides the automatic code generator 132 with a consistent architecture for stitching together various code blocks.

Firmware stack 200 includes a system layer 202, a hardware encapsulation layer 204, and a base project layer 206. The functionality of the system layer 202 is independent of the targeted processing device. Also, interfaces, such as Application Program Interfaces (APIs), made between system layer 202 and the remaining layers of firmware stack 200 are standardized regardless of the targeted processing device. The term “standardized” refers to the hardware independence of the APIs. This abstraction away from specific hardware allows system layer 202 to function without regard to the particular hardware. The low layers of firmware stack 200 have “knowledge” of the specific hardware and take care of the implementation details for the system layer 202.

The hardware encapsulation layer 204 and the base project layer 206 are generated based at least in part on the targeted processing device. Hardware encapsulation layer 204 represents the underlying hardware to system layer 202. Base project layer 206 includes a set of standard functions associated with the targeted processing device hardware. Base project layer 206 may include functionality at the register level of the targeted processing device.

System layer 202 may include transfer functions 708 and drivers 712. System layer 702 is targeted by an application level mapping function. Transfer functions 208 invoke the transfer functions defined by the user. Generally, a transfer function defines the behavior of an output device in response to one or more inputs. The transfer functions are the highest level of the code. They have no knowledge about any hardware. They only know about variables set by a driver or used to set the output of a driver.

Drivers 212 represent I/O and interface devices to the user. In one embodiment, drivers 212 may include three types: input, output, or interface. An output driver may be used with a device that is controlled by the user application, such as a fan or heater. Input drivers may be used for sensors, such as temperature or voltage sensors. Interface drivers may be used for devices that allow access to system variables and status, such as an Inter-Integrated Circuit (I2C) or a Serial Peripheral Interface (SPI).

Transfer functions 208 and drivers 212 may communicate with each other using APIs. Examples of APIs may include DriverName-Instantiate to initialize a device, DriverName_Get Value to return a value from an input device, and DriverName_Set Value to set an output of an output device to a specific value. These APIs are defined such that they may be invoked regardless of the particular hardware.

Drivers 212 communicate with hardware encapsulation layer 204 that include channels 224. Drivers include driver metadata and source code templates. In one embodiment, drivers 212 contain source code that converts channel information to a higher-level meaning. For example, the LM20 driver converts low-level voltage measured by the mVolts channel and converts it to its respective temperature value.

Channels 224 are hardware independent and are usually defined to provide a generic resource. These generic resources may be, for example, voltage measurements, PWM (pulse-width modulation) outputs, general purpose I/O, etc. A channel may be further defined by a channel type, such as an input voltage channel, an output voltage channel, or the like. Channels 224 provide a platform for drivers 212 and dictate the interface between the base project layer 206 and drivers 212. A channel may create a defined interface that many drivers may use. For example, several different drivers can use the mVolts channel. These drivers can be associated with any device that measures some stimulus such as temperature, pressure, force, etc and output a voltage.

Channels 224 include channel metadata and source code templates. The channel metadata is used to map drivers 212 onto the base project 220. The source code templates are used to generate the embedded application project. Channels 224 may also include low level code 214 and user modules 216. Low level code 214 provides the implementation of channels 224. User modules 216 perform hardware functions (e.g., analog to digital conversion) required by drivers. User modules 216 may be used with block arrays in processing device hardware 218 to form hardware components, such as an Analog-Digital Converter (ADC). Channels 224 are “placeable” because they are not initially tied to any particular base project but are instead added to a specified base project at a later time if the specified base project has sufficient hardware resources.

The base project layer 206 includes a base project 220 associated with a specific processing device such as the targeted processing device 140. The base project 220 includes a core device project 222 that describes unique configuration characteristics of the processing device (e.g., pin configuration that can be applied to the processing device), and processing device hardware 218.

The firmware stack model 200 enables the creation of an appropriate project for an application based on the channel assignments of the drivers. This project creation process also referred to herein as a base project synthesis is guided by the channel and driver metadata, source file templates and user selections.

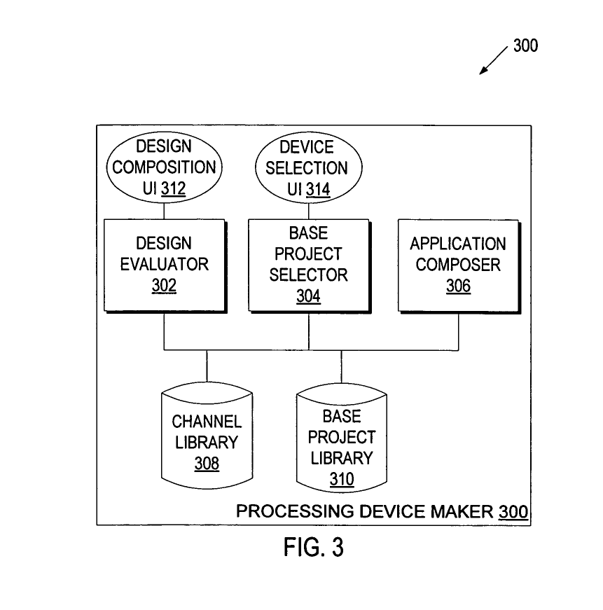

FIG. 3 is a block diagram of one embodiment of a processing device maker 300. The processing device maker 300 includes a design evaluator 302, a base project selector 304, a custom application composer 306, a design composition UI 312, a device selection UI 314, a channel library 308, and a base project library 310.

The design evaluator 302 is responsible for evaluating, in real-time, an application design composed by a user via the design composition UI 312. The design composition UI 312 allows a user to add new device drivers to the design, delete existing device drivers, set properties of device drivers, and perform various other changes to the design. An exemplary design composition user interface will be discussed in more detail below in conjunction with FIG. 4.

As the user composes the application design, the design evaluator 302 detects changes to the design and determines resource needs associated with the new design. In particular, in one embodiment, the design evaluator 302 identifies channel types required by device drivers selected by the user, and determines resource needs specified by the channels. The resource needs may include, for example, blocks and pins to be used by user modules associated with the channels. In one embodiment, the design evaluator 302 accesses the channel library 308 to find channel metadata describing resource needs pertaining to corresponding channels.

Further, the design evaluator 302 assesses the resource needs of the user design against available base projects to identify applicable base projects that can accommodate the user design. In one embodiment, the design evaluator 302 accesses the base project library 310 to find base project metadata describing hardware resources pertaining to each base project.

As discussed above, each base project corresponds to a specific processing device. In one embodiment, processing devices of the same type are grouped into a device family. The processing devices in the device family differ primarily in the number of pins. In one embodiment, when the design evaluator 302 performs the assessment of the user design, it uses only base project with the largest number of pins for each device family, thus reducing the number of base projects used for the assessment.

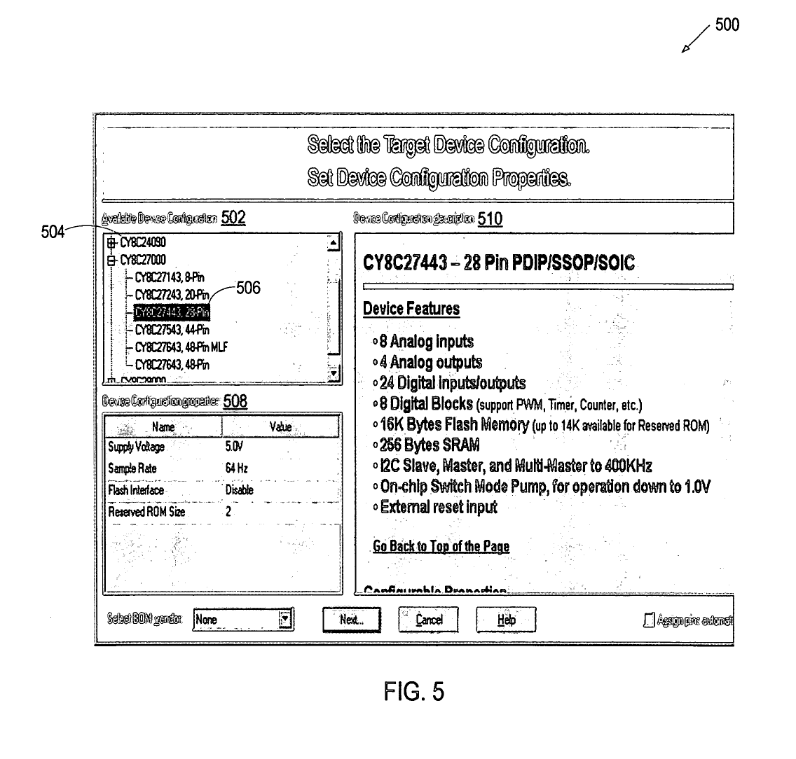

The base project selector 304 presents a list of applicable base projects to the user and receives a user selection of a desired base project via the device selection UI 314. An exemplary device selection UI will be discussed in more detail below in conjunction with FIG. 5. In one embodiment, the base project selector 304 compiles the list of applicable base projects using the device families identified by the design evaluator 302. For each identified device family, the base project selector 304 selects only processing devices that can accommodate the user design, and adds base projects associated with these processing devices to the list of applicable base projects. The base project selector 304 may also provide a list of properties for the user to specify for the currently viewed base project selection.

The custom application composer 306 is responsible for constructing a final embedded application using the base project selected by the user. In one embodiment, upon receiving a user selection of the base project, the custom application composer 306 creates a channel instance for every driver in the user design, maps these channel instances onto resources included in the selected base project, places user modules associated with each channel instance, and sets user module parameters according to the design requirements.

FIG. 4 illustrates an exemplary design composition user interface 400. The UI 400 includes tabs and buttons for various stages in designing the user application. These tabs include Design 402, Simulation 404, and Bill of Materials/Schematic (BOM/Schem) 406. The Design tab 402 may be used for designing the user application. The Simulation tab 404 provides a software simulation of the user's application. The BOM/Schem tab 406 is used to generate a bill of materials, schematic and/or a datasheet for the user's application. The UI 400 may also include a Build button 408 that can invoke the automated code functionality to automatically generate code for the user application without requiring the user to write any code.

The UI 400 also includes a workspace area 418 and a tray area 416. The user may use the tray 416 to select desired objects such as inputs, outputs and valuators, and drag them to the workspace area 418. In the example of FIG. 4, the user has dragged input 410 and output 412. The input 410 is a push-button switch. The output 412 is a light-emitting diode (LED) whose state is controlled by the switch position. The LED 412 is associated with a transfer function 414 that defines its behavior. In the example of FIG. 4, the transfer function 4141 may be defined such that when the switch 410 is pressed, the LED 412 is on, and when the switch 410 is released, the LED 412 is off.

In one embodiment, when the user selects a device, a corresponding driver type is identified, and a driver instance is created for the design. Generally, a driver instance includes several components for device selection and code generation. In one embodiment, the driver components include user-interface/documentation files, metadata/fragments files, and source code files. The interface/documentation files may include files to generate the visual interface in the UI 500 (e.g., the icon displayed on the workspace, datasheet, schematic and BOM data). The metadata files may include a DriverName.cmx file that specifies how the driver is displayed in the selection catalog, what interface functions it has, what channel type it needs, and the hidden and user settable properties. The fragments file may include a Frags.tpl file that contains the code fragments that are processed by the code generator. These processed fragments are then available as substitutions into the driver source code files. Some of these fragments are placed into a common set of files for use by other parts of the application. The source code files may include the driver firmware files. These files may implement the interface functions used by the system and may include processed code fragment strings to generated customized code.

As discussed above, in one embodiment, when the user makes changes to the design (e.g., by adding/deleting I/O devices or modifying device properties that have resource allocation implications), the design evaluator 302 accesses resources needed for the new design in real time and identifies applicable base projects that can accommodate the new design. Subsequently, when the user issues a request to build processing device code (via the build tab 408), the user is presented with a device selection UI that allows the user to select a base project for a specific processing device.

FIG. 5 illustrates an exemplary device selection UI 500. The UI 500 presents a list 502 of base projects in the form of a tree view, where the major branches reflect device families 504 capable of accommodating resource needs of the user design and the minor branches reflect the available devices 506 within each family 504. The available devices are identified by assessing the resource needs of the user design against each processing device within the family and filtering devices with insufficient hardware resources. The base project 506 is highlighted because it was previously selected and it has sufficient resources for the currently selected driver set. Alternatively, if no base project with sufficient resources was previously selected, then that base project at the top of the tree would be highlighted.

The UI 508 also includes device configuration description 510 of the processing device 506 and its device configuration properties 508 that can be modified by the user.

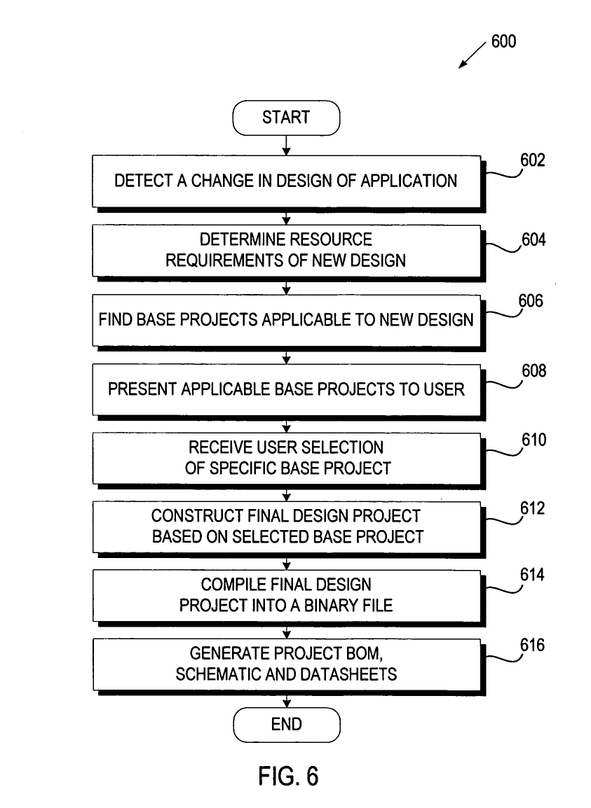

FIG. 6 is a flow diagram of one embodiment of a method 600 for constructing a custom application. The method 600 may be performed by processing logic of the processing device maker 106 and processing device designer 130. Processing logic may comprise hardware (e.g., circuitry, dedicated logic, programmable logic, microcode, etc.), software (such as run on a general purpose computer system or a dedicated machine), or a combination of both.

Referring to FIG. 6, method 600 begins with detecting, in real-time, a change in a user design of an application (block 602). The user design may consist of various I/O and interface devices and valuators that are selected by the user via a designated UI. In one embodiment, each device is associated with a driver that represents a relevant device to the user. A driver may have a set of properties that can be predefined or specified by the user. Changes to the user design may include, for example, addition of a new driver, deletion of an existing driver, and modification of driver properties that have resource allocation implications (e.g., modification of a channel type associated with the driver, etc.).

At block 604, processing logic determines resource requirements of the new design. The resource requirements may include, for example, the number of blocks and pins needed to accommodate the combination of drivers in the user design. In one embodiment, each driver specifies a channel type that defines resource requirements such as blocks and pins required for user modules performing the functionality of the relevant driver.

At block 606, processing logic finds base projects applicable to the user design by assessing resource requirements of the user design against hardware resources associated with available base projects. In one embodiment, processing logic uses for assessment only one base project per device family, where this base project is for the processing device with the largest number of pins in the device family.

At block 608, processing logic presents the applicable base projects to the user. In one embodiment, the applicable base projects include base projects of available processing devices within each device family. The available processing devices are those that have sufficient hardware resources for the current user design. Hence, processing logic filters processing devices with insufficient resources within the device family while testing only those devices whose family has sufficient resources for the currently selected driver set.

At block 610, processing logic receives user selection of a base project for a specific processing device (e.g., via a device selection UI).

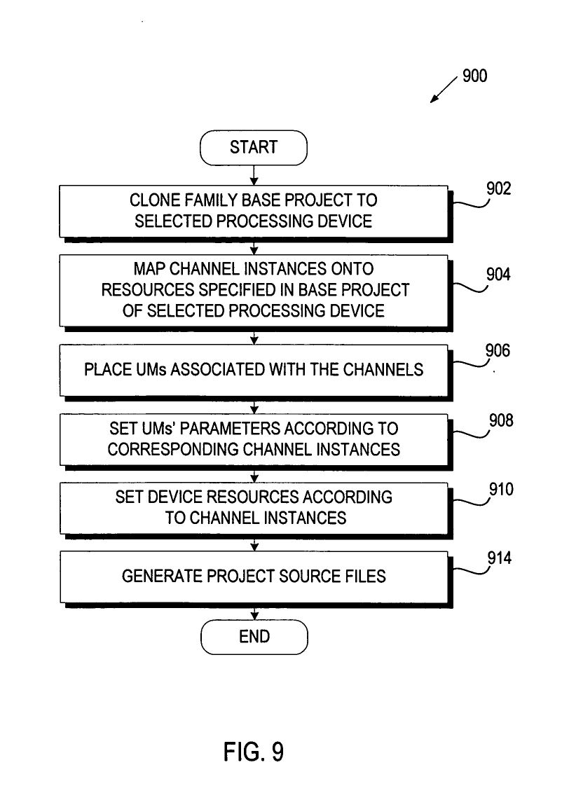

At block 612, processing logic constructs the final application project based on the selected base project. In one embodiment, the construction includes selection and placement of user modules, setting of resources such as row inputs and global inputs, and generation of source files such as driver source files and system source files. One embodiment of a method for constructing a final design project is discussed in mode detail below in conjunction with FIG. 9.

At block 614, processing logic compiles the final design project into a binary file that can be downloaded to the designated processing device.

At block 616, processing logic generates BOM, schematic and datasheets for the project.

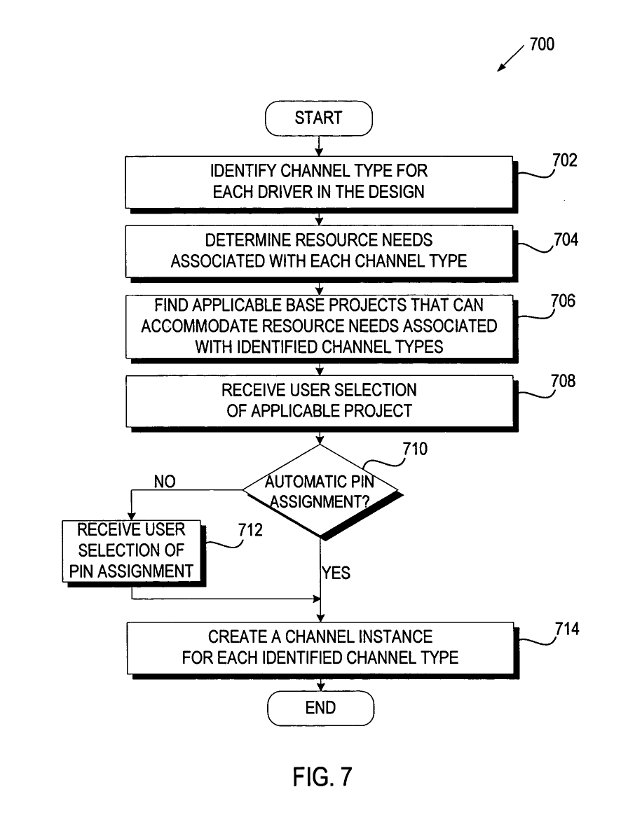

FIG. 7 is a flow diagram of one embodiment of a method for instantiating channels for a specific base project. The method 700 may be performed by processing logic of the processing device maker 106. Processing logic may comprise hardware (e.g., circuitry, dedicated logic, programmable logic, microcode, etc.), software (such as run on a general purpose computer system or a dedicated machine), or a combination of both.

Referring to FIG. 7, method 700 begins with identifying a channel type for each driver in the user design (block 702). In particular, when the user selects a device driver, a channel type required for this driver is identified based on relevant driver metadata. In one embodiment, if no channel can be assigned to a driver selected by a user (e.g., if the selected driver is not supported by any channel or there are too many channels of that type already in use), the user will be notified that the driver selection exceeds the current capacity of the system.

At block 704, processing logic determines resource needs for each channel type identified at block 702. In one embodiment, processing logic determines the resource needs using channel metadata that defines user modules and device routing resources that are dedicated to the channel.

At block 706, processing logic finds applicable base projects that can accommodate the channels' resource needs. In one embodiment, processing logic first identifies, for each device family, a base project for the processing device with the largest number of pins in the family, and then determines whether this base project can accommodate the combination of channel types in the current design. In one embodiment, processing logic makes this determination based on relevant base project metadata that describes hardware resources of the corresponding processing device. In addition, the base project metadata may specify what channels are allowed to be added to this base project.

At block 708, processing logic receives the user's selection of one of the applicable base projects.

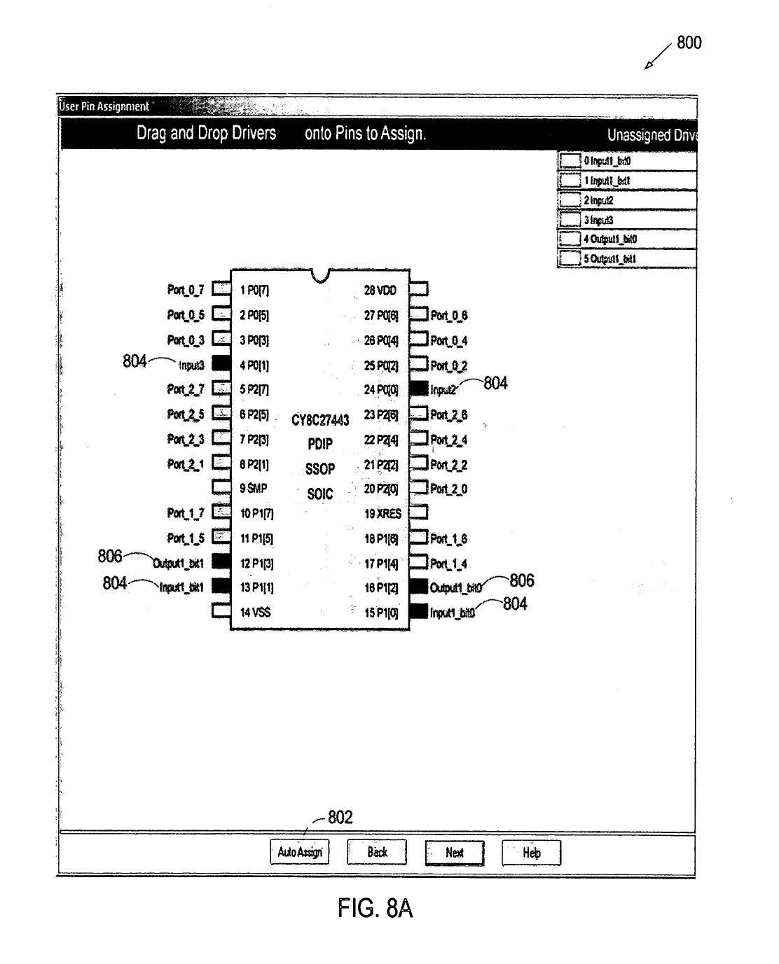

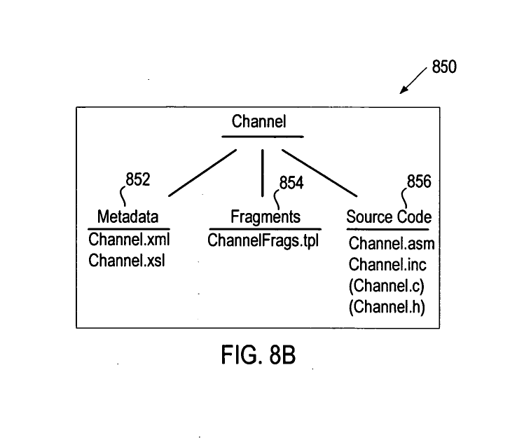

Next, if a manual pin assignment is used (block 710), processing logic allows a user to specify the pin assignments for the drivers (block 712). An exemplary pin assignment UI will be discussed in more detail below in conjunction with FIG. 8. In one embodiment, when the user changes the pin assignment for a driver, processing logic determines whether the channel type pertaining to the driver supports the new pin assignment. If not, processing logic may assign a different channel type to the driver or disallow the user to choose this pin assignment. The channel type may support the new pin assignment if the relevant channel metadata marks this hardware resource requirement as “assignable”. When the resource requirement is marked as assignable, any hardware resource will satisfy the requirement as long as the hardware resource is of the correct type.

At block 714, processing logic creates a channel instance for each channel type identified for the current design. Each channel instance has a specific ID number that uniquely identifies the channel instance. If processing logic uses automatic pin assignment, the pin assignment is calculated when creating the channel instance. In one embodiment, the pin assignment is calculated using a pin priority list included in the channel metadata. The pin priority list specifies which pins should be assigned during automatic pin assignment.

FIG. 8A illustrates an exemplary pin assignment UI 800. The UI 800 includes an auto assign button 802 that triggers an automatic assignment of pins for the project. Alternatively, the user can manually specify the desired pin assignments by moving input drivers 804 and output drivers 806 to specific pins.

As discussed above, drivers selected by a user for the design specify particular channels. Channels represent resource needs of a particular hardware function. Drivers use channels to implement their functionality. Channels allow mapping of hardware functions to a base project based on the hardware resources of the base project. Channels are referred to herein as placeable because they are not initially tied to any particular base project but are instead added to a specified base project at a later time if the specified base project has sufficient hardware resources.

FIG. 8B illustrates data components of a placeable channel 850. The channel 850 includes metadata 852, fragments 854, and source code templates 856. The metadata 852 is used by the processing device maker 106 for resource management (e.g., to map drivers into the base projects that contain enough resources to implement the required functionality). The source code templates 856 are used for code generation (to generate the embedded application project).

The channel source code accesses the processing device hardware through the user module API or directly through the I/O registers. A channel instance defines a particular user module placement and resource configuration on the device. There may be multiple instances of a given channel (also referred to as a channel type) used simultaneously within a user application. In one embodiment, certain channel instances may be restricted by the routing resources within the processing device and the resource needs of other channel types. Because base projects have differing resources depending on the processing device hardware, the processing device maker 106 calculates resource usage of a project and fits the necessary channels onto the device by selecting appropriate Channel Instances. The user's pin assignment also guide the selection of channel instances by the processing device maker 106.

As shown in FIG. 8B, the channel metadata 852 may include XML metadata and an XSL file. The Channel metadata 852 may hold a list of possible placeable channel instances available in the system. Each channel instance describes a particular user module (UM) placement and its parameter settings, as well as a list of hardware resources used by the channel instance. Each channel instance may also have a substitution list which provides a mechanism for tailoring the source code for a specific instance. Hardware resource requirements defined the channel instance may be marked as “assignable,” which allows the selection of any hardware resource of the particular processing device as long as this hardware resource is of the correct type. This enables automatic calculation of pin assignment and routing.

The XML metadata may also include a pin priority list for the channel. The pin priority list specifies which pins should be assigned during automatic pin assignment.

In addition, the XML metadata may include a set of channel properties. In one embodiment, the properties are set by drivers to customize a channel for the specific driver's needs. In one embodiment, the customization is accomplished by making substitutions into the channel source code depending on the property setting choice. In another embodiment, the customization is accomplished by setting user module parameters based on the channel property setting choice.

Further, the XML metadata may include a template file list that specifies what pieces of source code should be included for the channel to provide its function. This source code is accessed by the driver to provide the hardware function.

The XSL file is used to expand nodes in the channel metadata according to patterns that exist in the XML schema. The expansion makes the channel metadata less verbose so that it is easier for content authors to read and to modify the metadata.

The XSLT (Extensible Stylesheet Language Transformation) script processes the XML metadata and the XSL file to expand a smaller XML dataset into a larger XML dataset used for the generation of embedded application code.

The fragments file 854 includes code fragments used during code generation. These fragments are gathered and interpreted by the code generator for use in the channel source files and in the system source files that have global system substitutions. These fragments allow code to be generated for each specific instance of the channel in the project. When the string “CHANNEL_TYPE” is used, each of the used channel instance names is substituted. This can be used to gather fragments from multiple channel instances in the main file template.

The source code templates 856 provide an interface to the hardware for the driver. The channel has a set of API functions and global data available to the driver. The channel API functions make appropriate calls to the user module API functions to perform the hardware task. String substitutions from the fragments 854 are made in the channel source code 856. The substitution strings may be different depending on the particular channel instance. This makes channels “placeable” depending on the user's pinout selections and available hardware resources. The channel source code templates 856 may have placeholders that are substituted with the appropriate UM instance name or register address for the particular channel instance. The channel source code templates 856 may also have placeholders that are substituted with the channel property settings chosen by the driver.

Channel source code fragments may be pieced together with the correct substitutions to form the complete source code for a channel instance. There may be more or less source code generated for a channel type depending on the number of channel instances in use in the application. Each channel instance has a specific ID number that uniquely identifies the channel instance. The channel API functions may be passed with the channel ID as an argument. The channel ID may be used to execute the correct portion of code for each instance.

In one embodiment, a channel type may allow for hardware resource sharing across instances of that channel type. A channel instance that allows other channel instances of the same channel type to share its UM instances and a set of hardware resources is called a shared channel. The shared channel metadata specifies the maximum number of regular channel instances that can share resources of the shared channel. When a regular channel instance needs to use the resources of a shared channel, it specifies in its metadata the shared channel type it needs to use. The system calculates the resource usage of the shared channel and permits only the allowed number of regular channel instances to use the shared channel resources. Shared channels allow for more efficient usage of user modules and, in turn, the base project resources so that more driver combinations are possible.

In one embodiment, a channel may need to be implemented differently on various processing devices. The channel metadata may include a dependent device list that specifies device families on which the channel may be used. If a particular channel type needs to have multiple implementations, separate metadata and source code may be created for different processing devices and differentiated using the dependent device list. The use of device specific channels reduces the number of channel and driver types. Without device specificity, distinct channel types would be needed as well as distinct driver types for each part that diverged from the architecture of existing devices.

Various channel types may be predefined to implement hardware functions of device drivers. Exemplary channel types may be as follows:
CMX_DIGITAL_IO_CHAN—provides control of an I/O pin.
CMX_ECO_CHAN—provides support for an external crystal oscillator.
CMX_I2C_IFC_CHAN—provides I2C Slave communication support.
CMX_I2Cm_CHAN—provides I2C Master communication support.
CMX_MVOLTS_CHAN—provides Analog to Digital conversion of voltage inputs.
CMX_PWM_CHAN—provides a PWM output.
CMX_SW_CHAN—channel for software drivers (no hardware resources needed).
CMX_TACH_IN_CHAN—provides tachometer readings by measuring frequency of an input signal.
CMX_WDT_CHAN—provides a resetable countdown timer.

Placeable channels provide a well-defined interface that may be used by multiple drivers across the range of base projects, instead of a driver interface that is tightly coupled to a particular base project. The use of placeable channels allows for mixing and matching of hardware resources as long as the processing device can support the needed resources. This provides maximal utilization of the processing device hardware resources for a given project. Without placeable channels, an unmanageable number of base projects would have to be created to cover the possible combinations of user module placements. In addition, dynamic UM placement provided by placeable channels enables flexible pin assignment that can be either automatic or specified by a user via a user interface.

FIG. 9 is a flow diagram of one embodiment of a base project synthesis method 900. The method 900 may be performed by processing logic of the processing device maker 106. Processing logic may comprise hardware (e.g., circuitry, dedicated logic, programmable logic, microcode, etc.), software (such as run on a general purpose computer system or a dedicated machine), or a combination of both.

Method 900 uses a base project synthesis mechanism that hides the actual base projects by operating on metadata that represent base projects that do not physically exist as fixed entities. The user inputs and the metadata are combined and processed to create a virtual base project that ultimately results in a final embedded application project.

Base project metadata data includes device family metadata associated with device family base projects and device specific metadata associated with device specific base projects. The device family base project is made device specific by adding the contents of the device specific metadata.

Device family metadata is specified for each device family. The device family metadata describe the channels that can co-exist on the device and any channels that are fixed because specific code is needed to manage combinations of channels. For example, certain combinations of interface channels need code specific to coordination between the channels. The channel descriptions for the device family metadata may contain the part resources needed to instantiate the channel that are related to the particular part family, but not those resources needed to connect the channel to the pins.

Device specific metadata is specified for each part within a family. The device specific metadata may describe the pin configuration that can be applied to the device. The pin assignments may be prioritized by channel type. Additional pin prioritizations can be applied through named prioritizations. The drivers can then arbitrarily map to particular prioritization names.

Referring to FIG. 9, method 900 begins with processing logic cloning a corresponding device family base project to the processing device designated by the selected device specific base project (block 902). This may include copying standard files and user module configuration employed by the base project to the correct device. The standard files may include templates with placeholders for adding source code such as driver source code, channel source code, etc.

At block 904, processing logic maps channel instances used in the project onto resources included in the device specific base project.

At block 906, processing logic selects and places user modules associated with the channel instances used in the project. The channel instances specify the type and block placement of their user modules.

At block 908, processing logic sets the user modules' parameters according to the channel instances' metadata.

At block 910, processing logic sets device resources such as row inputs and global inputs according to the channel instances' metadata.

At block 914, processing logic generates project sources files such as driver source files, channel source files, and system source files.

The resulting embedded application project can then be compiled to a binary file that may be downloaded to the designated processing device.

It will be appreciated that base project resource management and application synthesis described herein enable flexible user module placement limited only by the resources available on the device. The final embedded application includes only code employed by drivers for channel implementation and only user modules employed by drivers for placement, excluding unneeded driver and user module code from the final embedded application.

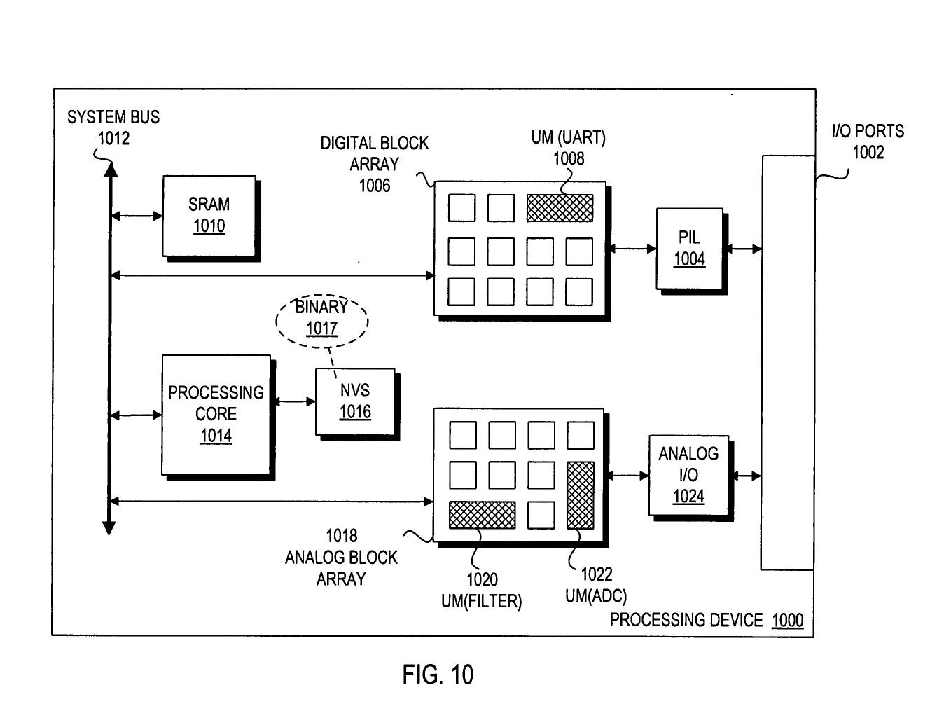

Turning to FIG. 10, an embodiment of a processing device 1000 is shown. Processing device 1000 includes a microcontroller. Processing device 1000 includes Input/Output (I/O) ports 1002. In one embodiment, I/O ports 1002 are programmable. I/O ports 1002 are coupled to a Programmable Interconnect and Logic (PIL) 1004 which is coupled to a digital block array 1006. In FIG. 10, digital block array 1006 includes a UM 1008 that has been configured as a Universal Asynchronous Receive/Transmitter (UART). Digital block array 1006 is coupled to a system bus 1012.

A Static Random Access Memory (SRAM) 1010 and a processing core 1014 are also coupled to system bus 1012. Processing core 1014 is coupled to NVS 1016 which has stored a binary 1017. In one embodiment, binary 1017 includes instructions generated as described herein. In another embodiment, binary 1017 may include instructions executable by processing core 1014 as well as instructions for configuring block arrays 1016 and 1018.

Analog block array 1018 is coupled to system bus 1012. In the embodiment of FIG. 10, analog block array 1018 includes a UM 1020 configured as a filter and a UM 1022 configured as an ADC. Analog block array 1018 is also coupled to an analog I/O unit 1024 which is coupled to I/O ports 1002. Processing device 1000 may also include other components, not shown for clarity, including a clock generator, an interrupt controller, an I2C, or the like.

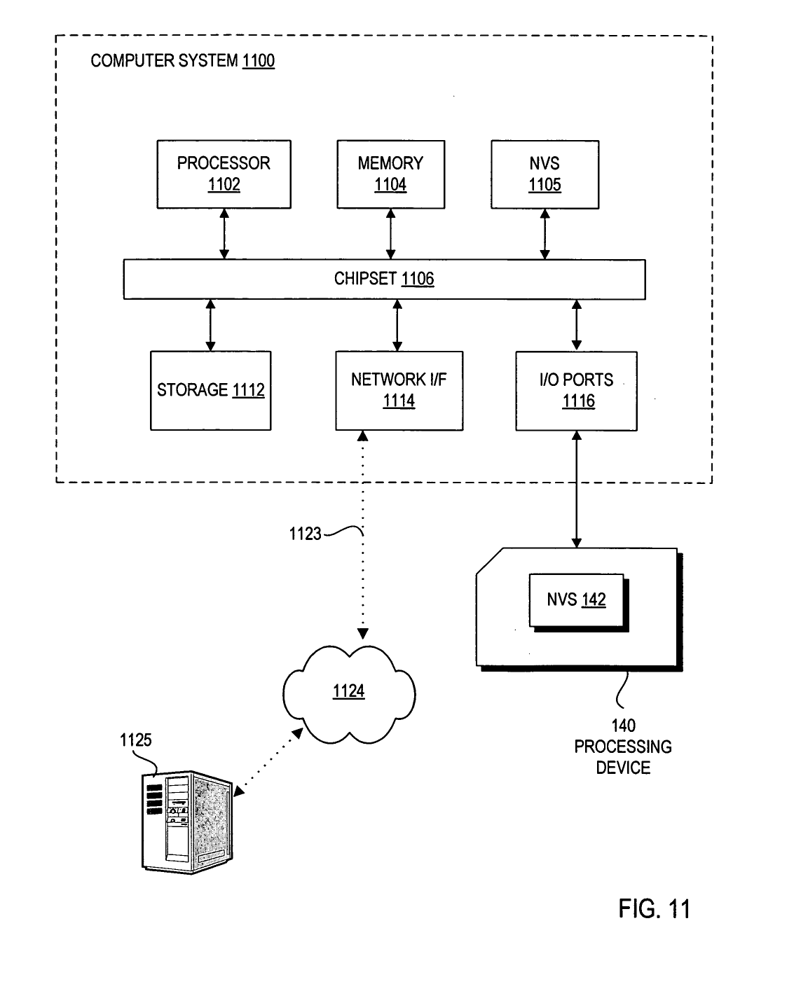

FIG. 11 illustrates an exemplary computer system 1100 on which embodiments of the present invention may be implemented. Computer system 1100 includes a processor 1102 and a memory 1104 coupled to a chipset 1106. Storage 1112, Non-Volatile Storage (NVS) 1105, network interface (I/F) 1114, and Input/Output (I/O) ports 1118 may also be coupled to chipset 1106. Embodiments of computer system 1100 include, but are not limited to, a desktop computer, a notebook computer, a server, a personal digital assistant, a network workstation, or the like. In one embodiment, processor 1102 executes instructions stored in memory 1104.

Memory 1104 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like.

Chipset 1106 may include a memory controller and an input/output controller. Chipset 1106 may also include system clock support, power management support, audio support, graphics support, or the like. In one embodiment, chipset 1106 is coupled to a board that includes sockets for processor 1102 and memory 1104.

Components of computer system 1100 may be connected by various interconnects. Such interconnects may include a Peripheral Component Interconnect (PCI), a System Management bus (SMBUS), a Low Pin Count (LPC) bus, a Serial Peripheral Interface (SPI) bus, an Accelerated Graphics Port (AGP) interface, or the like.

I/O ports 1116 may include ports for a keyboard, a mouse, a display, a printer, a scanner, or the like. Embodiments of I/O ports 1116 include a Universal Serial Bus port, a Firewire port, a Video Graphics Array (VGA) port, a Personal System/2 (PS/2) port, or the like.

Processing device 140 may be coupled to computer system 1100 via I/O ports 1116. Computer system 1100 may have stored computer-readable instructions, in accordance with embodiments described herein, to allow a user to design the application 122 using UIs described herein and automatically generate processing device code for processing device 140 using computer system 1100. This code may be compiled into a binary and loaded into NVS 142.

Computer system 1100 may interface to external systems through network interface 1114. Network interface 1114 may include, but is not limited to, a modem, a Network Interface Card (NIC), or other interfaces for coupling a computer system to other computer systems. A carrier wave signal 1123 may be received/transmitted by network interface 1114. In the embodiment illustrated in FIG. 11, carrier wave signal 1123 is used to interface computer system 1100 with a network 1124, such as a Local Area Network (LAN), a Wide Area Network (WAN), the Internet, or any combination thereof. In one embodiment, network 1124 is further coupled to a computer system 1125 such that computer system 1100 and computer system 1125 may communicate over network 624.

Computer system 1100 also includes non-volatile storage 1105 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like. Storage 1112 includes, but is not limited to, a magnetic disk drive, a magnetic tape drive, an optical disk drive, or the like. It is appreciated that instructions executable by processor 1102 may reside in storage 1112, memory 1104, non-volatile storage 1105, or may be transmitted or received via network interface 1114.

For the purposes of the specification, a machine-readable medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-readable medium includes, but is not limited to, recordable/non-recordable media (e.g., Read-Only Memory (ROM), Random Access Memory (RAM), magnetic disk storage media, optical storage media, a flash memory device, etc.). In addition, a machine-readable medium may include propagated signals such as electrical, optical, acoustical or other forms of propagated signals (e.g., carrier waves, infrared signals, digital signals, etc.).

Various operations of embodiments of the present invention are described herein. These operations may be implemented by a machine using a processor, an Application Specific Integrated Circuit (ASIC), a Field Programmable Gate Array (FPGA), or the like. In one embodiment, one or more of the operations described may constitute instructions stored on a machine-readable medium, that when executed by a machine will cause the machine to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A computer-implemented method, comprising:
upon detecting a change to a design of an application, evaluating the design against hardware resources associated with application projects to identify one or more applicable application projects;
receiving a user selection of one of the applicable application projects; and
constructing the application using the selected application project.

2. The method of claim 1 wherein the application is an embedded application for a processing device.

3. The method of claim 1 wherein the change to the design comprises at least one of an addition of an application object, a deletion of an application object, and a modification of an application object property.

4. The method of claim 3 wherein the application object is any one of an application input, an application output, and a valuator.

5. The method of claim 1 wherein evaluating the design comprises:
identifying channels for drivers associated with the design;
determining, for each processing device family, whether the family can accommodate the identified channels; and
if the family can accommodate the identified channels, adding an application project associated with the family to a list of applicable application projects.

6. The method of claim 5 wherein the determination as to whether the family can accommodate the identified channels is performed using a processing device with the largest number of pins in the family.

7. The method of claim 5 wherein receiving a user selection of one of the applicable application projects comprises:
for each application project associated with a family, assessing all processing devices in the family to identify processing devices that can accommodate the identified channels;
for each family, presenting application projects associated with processing devices that can accommodate the identified channels; and
allowing the user to select one of the presented application projects.

8. The method of claim 1 wherein each of the applicable application projects comprises metadata describing resources available on a corresponding processing device.

9. The method of claim 8 wherein constructing the application comprises:
mapping the identified channels onto resources specified in the selected application project; and
placing user modules associated with the identified channels in the selected application project.

10. The method of claim 9 further comprising:
setting parameters pertaining to the user modules according to the identified channels.

11. The method of claim 1 further comprising:
compiling the constructed application into a binary file to be downloaded to a corresponding processing device.

12. An article of manufacture comprising:
a machine-readable medium including a plurality of instructions which when executed perform a method comprising:
upon detecting a change to a design of an application, evaluating the design to identify one or more applicable application projects;
receiving a user selection of one of the applicable application projects; and
constructing the application using the selected application project.

13. The article of manufacture method of claim 12 wherein:
the change to the design comprises at least one of an addition of an application object, a deletion of an application object, and a modification of an application object property; and
the application object is any one of an application input, an application output, and a valuator.

14. The article of manufacture method of claim 12 wherein evaluating the design comprises:
identifying channels for drivers associated with the design;
determining, for each processing device family, whether the family can accommodate the identified channels; and
if the family can accommodate the identified channels, adding an application project associated with the family to a list of applicable application projects.

15. An apparatus comprising:
an evaluator to detect a change to a design of an application, and to evaluate the design to identify one or more applicable application projects;
a application project catalog to allow a user to select one of the applicable application projects; and
a processing device designer to construct the application using the selected application project.

16. The apparatus of claim 15 wherein the application is an embedded application for a processing device.

17. The apparatus of claim 15 wherein:
the change to the design comprises at least one of an addition of an application object, a deletion of an application object, and a modification of an application object property; and
the application object is any one of an application input, an application output, and a valuator.

18. The apparatus of claim 15 wherein the evaluator is to evaluate the design by
identifying channels for drivers associated with the design,
determining, for each processing device family, whether the family can accommodate the identified channels, and
if the family can accommodate the identified channels, adding an application project associated with the family to a list of applicable application projects.

19. The apparatus of claim 15 wherein each of the applicable application projects comprises metadata describing resources available on a corresponding processing device.

20. The apparatus of claim 19 wherein the processing device designer is to construct the application by
mapping the identified channels onto resources specified in the selected application project, and
placing user modules associated with the identified channels in the selected application project.
